(19) United States
(12) Patent Application Publication
(10) Pub. No.: US 2011/0025080 A1
(43) Pub. Date: Feb. 3, 2011

(54) SAFETY BUMPER

(76) Inventor: Sandeep Kumar Anand, Berkshire (GB)

Correspondence Address: HAYES SOLOWAY P.C., 3450 E. SUNRISE DRIVE, SUITE 140, TUCSON, AZ, 85718, US

(21) Appl. No.: 12/936,371

(22) PCT Filed: Mar. 23, 2009
(86) PCT No.: PCT/GB2009/050264

§ 371 Date: Oct. 4, 2010

(30) Foreign Application Priority Data
Apr. 3, 2008 (GB) 0806072.5
Jun. 16, 2008 (GB) 0810810.0
Jan. 19, 2009 (GB) 0900840.0

(51) Int. Cl. B60R 19/02

(52) U.S. Cl. 293/102

(57) ABSTRACT

A safety bumper for a vehicle constructed from a lattice of interlocking panels (1). The panels are formed in an overall substantive V, D or triangular shape such that when vehicle collide they are deflected from each other and, moreover, the bumper lattice crumples to give a progressive deceleration which reduces the risk of injury or death to passengers in the vehicle.

### TECHINCAL FIELD

The invention relates to a safety bumper for cars and the like.

### BACKGROUND ART

When two vehicles collide with each other it is the sudden impact of the vehicles that causes injuries to the occupants or kills them.

This problem is addressed in modern cars by the introduction of a “crumple zone” where the bonnet of a car is constructed so it will be crushed on impact to provide a short distance of deceleration before the vehicle completely stops. In other words, energy is transformed by the deformation of the vehicle bonnet instead of being directly transmitted through the body of an occupant. However, the crumple zone only provides a small distance of linear deceleration and, furthermore, crumples from any frontal direction without any deflection.

### DISCLOSURE OF THE INVENTION

The main purpose of the present invention is to provide a bumper to prevent a sudden stop by absorbing shock impact and diverting oncoming vehicles after the collision.

In a broad aspect of the invention there is provided a safety bumper for a vehicle comprised of a lattice of elements formed in a V, D or triangular shape.

The main advantage of a substantially V-shaped bumper is to minimize injuries in vehicle accidents and save lives by providing a progressive deceleration (by virtue of differential resistance from the lattice) and deflecting effect in the event of an impact. It also economizes fuel consumption by reducing the drag factor from the front of the vehicle.

Preferably the thickness/weight of the elements are determined by the weight of the vehicle to which the bumper is to be attached.

In one form the lattice of elements, said elements are panels but these may be substituted by elongate elements, such as cylinders, packed in an overall triangular or v-shape.

In a preferred embodiment the bumper includes an exterior shock absorbing panel surrounding the lattice.

In a second aspect of the invention there is provided a passenger vehicle integrating a safety bumper according to any of the preceding claims into its bonnet.

### BRIEF DESCRIPTION OF DRAWINGS

FIG. 1 shows a safety bumper according to the invention fitted to a vehicle in motion;

FIG. 2 illustrates a parked vehicle with a safety bumper positioned vertically;

FIG. 3 shows inner and exterior side panels of a safety bumper according to the invention;

FIGS. 4A, 4B and 4C show detail of the lattice construction;

FIG. 5 shows top exterior panels of the bumper;

FIG. 6 shows a plan view of an embodiment where the safety bumper of the invention is built into the bonnet of a car,

FIG. 7 shows a side elevation view of the car from FIG. 6, and

FIGS. 8A and 8B show an alternative form of lattice structure for the bumper.

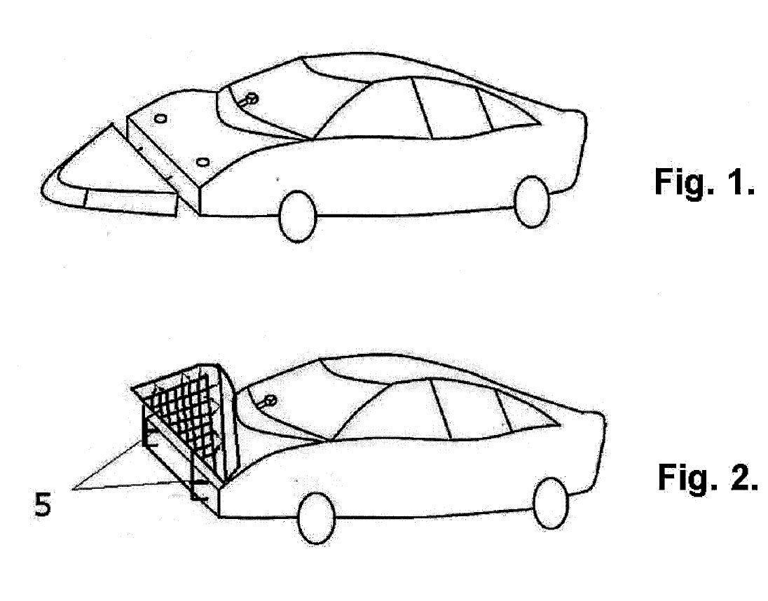

### MODE(S) FOR CARRYING OUT THE INVENTION

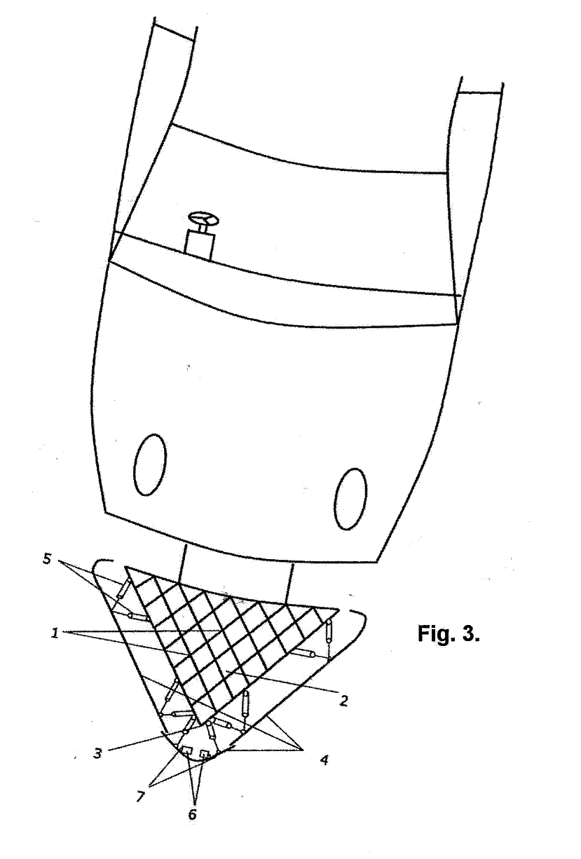

Referring to the drawings (particularly FIG. 3), the safety bumper of the invention is made of several elements, specifically panels 1, preferably of metal, vertically interlocked with each other to form a mesh or lattice pattern. The thickness of a panel can depend on the weight of the vehicle to which the bumper is fitted. The panels 1 effectively have diamond shaped gaps 2 between them and, on impact, are compressed to absorb most of the shock. During and after the collision, the V-shape 3 of the bumper pointing to the front diverts the colliding vehicles away from each other.

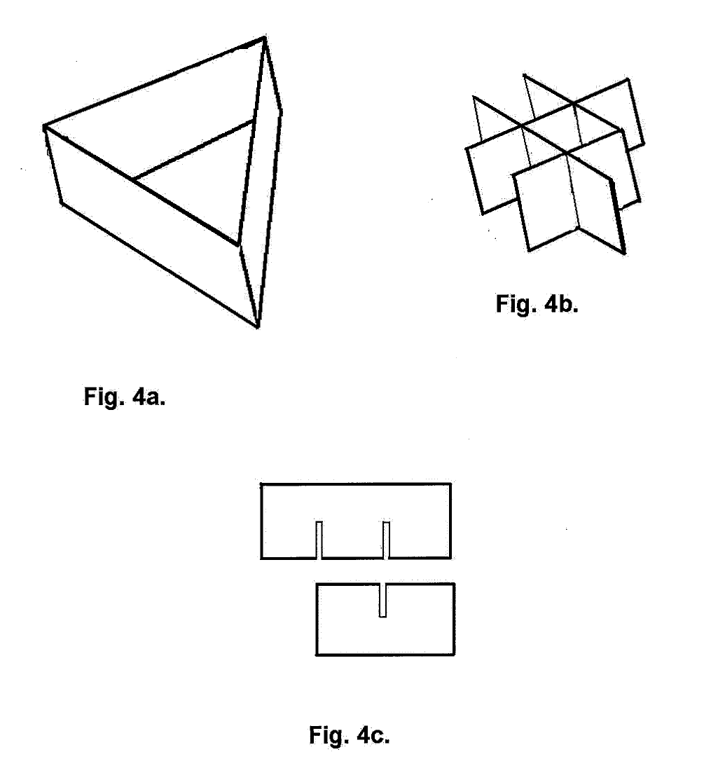

As best illustrated by FIG. 4C, each panel 1 consists of a generally elongate flat sheet (of metal) with notches cut out to mate with an adjacent panel. In practice the assembled lattice of FIG. 4B is mounted by its edge on top of a diamond-shaped array of metal bars (forming a supporting framework), e.g. by welding. It is generally positioned within a triangular enclosure as illustrated by FIG. 4A. It will be apparent that the number of panels can be varied to give any “density” of lattice within the triangularly shaped bumper. For example, the lattice of FIG. 3 is more “dense” and contains more panels than the simple lattice of FIG. 4.

On an impact with the bumper, the impacting object will (a) cause the array of metal bars, and (b) cause the interlocking panels, to crumple. If the impact is small enough, the bumper can be repaired. However, for larger impacts, it will usually be cheaper to remove the bumper (or the relevant parts) and replace them with fresh parts.

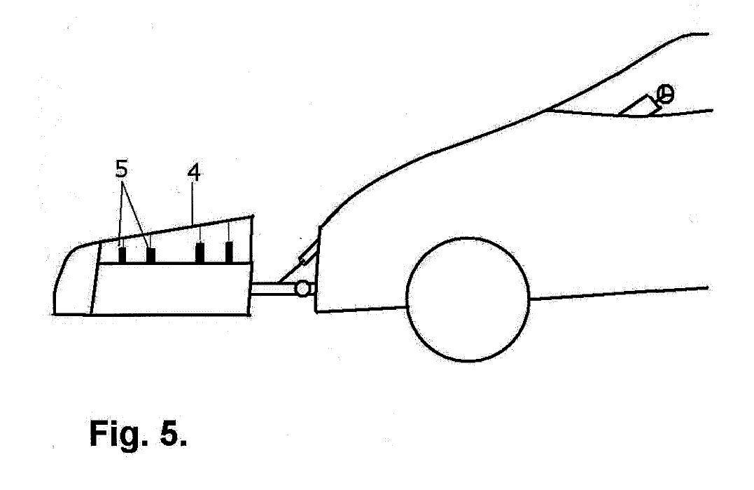

In FIGS. 3 and 5 the whole top, front, and sides of the bumper are fitted with exterior shock absorbing panels 4. Shock absorbers 5 attach these panels to the inner V shape bumper. The exterior panels can be made of soft shock absorbing metal, preferably with a rubber coating, resulting in minimum injuries to pedestrians if hit by the vehicle. In one embodiment the exterior panels can also be connected to the vehicle brakes, so any impact on these exterior panels will trigger the locks (or anti-lock braking system—ABS) on all the brakes. In a minor collision, a release button fitted inside the vehicle can release these locks on the brakes.

It is preferable to have a narrower forward end of the bumper to provide a differential crumple, i.e. because of the diamond structure the first part to take the impact is the pinnacle diamond, followed by the subsequent rows of diamonds. As such the resistance to impact increases as the bumper crumples until it reaches a maximum resistance at the base of the triangular shape. The overall bumper is preferably a V-shape but may also be a D shape to achieve differential crumpling.

The bumper of the invention increases the length of the vehicle, making it difficult to park in small places, i.e. car parks, driveways, etc. To overcome the increased length of the vehicle for parking, the bumper can be raised vertically as shown in FIG. 2, by means of hydraulics 5 similar to a tail-lift mechanism in a truck. In the same manner the bumper can also be raised 10 to 15 degrees on speed ramps.

The increased length of the bumper may also cause difficulty for the driver to pull out safely at some crossroads or junctions with blind spots, i.e. a narrow road joining the main road, unable to see the traffic clearly, pulling out of driveways, etc. To overcome this problem, two cameras 6 can be fitted inside the front panel of the bumper, pointing left and right, mounted behind transparent windows 7.

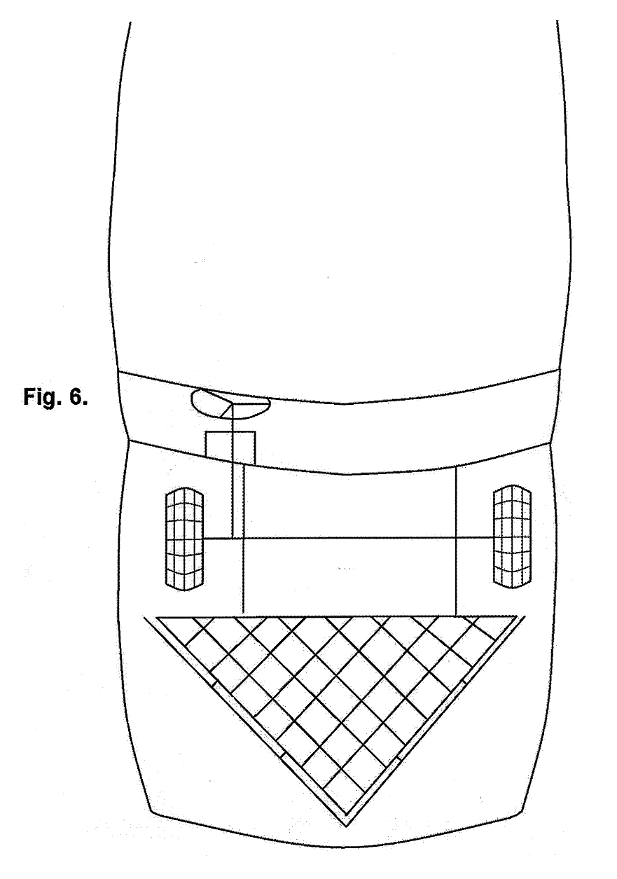

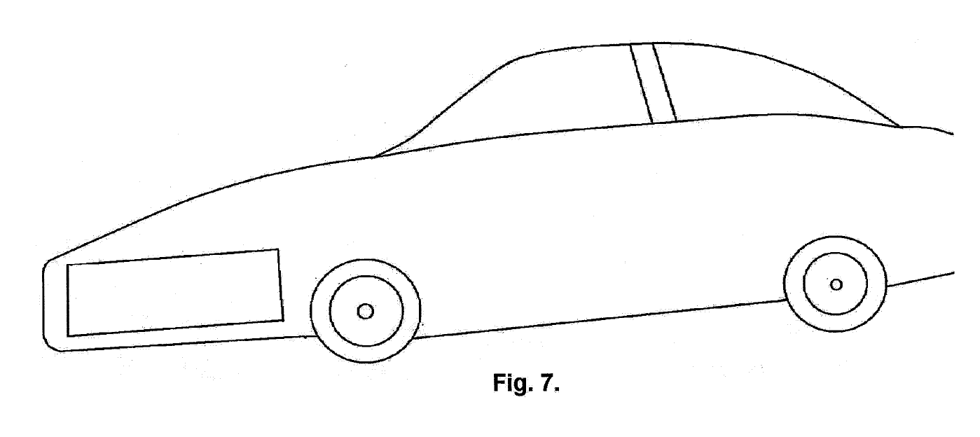

The bumper of the invention can also be integrated inside the bonnet of a vehicle, eliminating the cameras and tail-lift mechanism, as shown in FIGS. 6 and 7. In this form the car can have a more conventional appearance, although the wheels are still preferably behind the safety bumper. The surrounding bonnet can be made of relatively light metal, such that the main impact from a collision is taken by the (internal) bumper and its deflection feature is still retained.

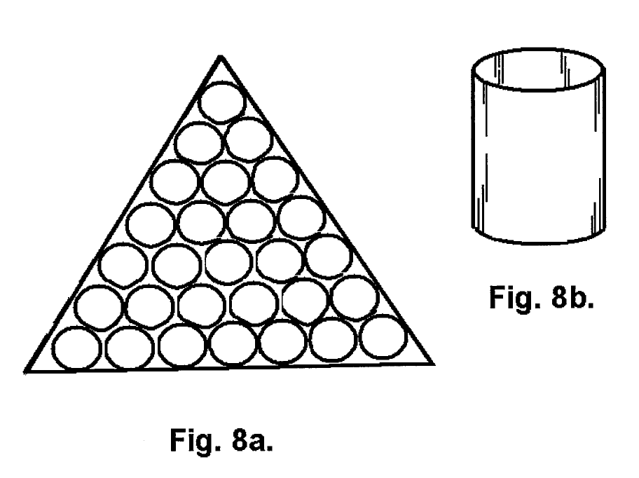

FIGS. 8A and 8B illustrate an alternative form of lattice wherein the impact absorption aspect of the bumper is provided by tightly packed cylindrical elements. The overall bumper shape (FIG. 8A) is still a triangle to retain the deflective feature.

In further forms the lattice could be a honeycomb (hexagonal/octagonal shape) or even comprised of spheres to provide progressive resistance upon impact.

### INDUSTRIAL APPLICABILITY

The bumper of the invention is preferably constructed from aluminium or a similar light weight construction using available manufacturing techniques.

1-9. (canceled)

10. A safety bumper for a vehicle comprised of:
a lattice of interlocking elements, the lattice formed in an overall substantially V, D or triangular shape narrowing away from a mounting end that mounts to a vehicle as viewed in plan view, whereby when a vehicle with a said safety bumper collides with another vehicle the vehicles are deflected from each other and the bumper lattice crumples to give a progressive deceleration which reduces the risk of injury or death to passengers in the vehicle.

11. The safety bumper of claim 10, wherein the lattice has diamond, honeycomb or circular gaps between the elements.

12. The safety bumper of claim 10, wherein the lattice of elements comprise a lattice of panels that are mounted, extending perpendicularly, on a correspondingly shaped framework.

13. The safety bumper of claim 10, wherein the safety bumper further comprises a raising/lowering mechanism to be mountable on a vehicle.

14. The safety bumper of claim 10, wherein the thickness/weight of the elements are determined by the weight of the vehicle to which the bumper is to be attached.

15. The safety bumper of claim 10, wherein the safety bumper further comprises an exterior shock absorbing panel surrounding the lattice.

16. The safety bumper of claim 15, wherein the exterior shock absorbing panel further comprises a sensor for connecting to a braking system of the vehicle to which the bumper is attached.

17. The safety bumper of claim 10, wherein the safety bumper further comprises a camera mounted on or adjacent the lattice of elements.

18. A passenger vehicle integrating a safety bumper of claim 10 into its front hood.

19. A safety bumper for a vehicle comprised of:
a lattice of interlocking panels, the lattice formed in an overall substantially V, D or triangular shape as viewed in plan view, whereby when a vehicle with such a safety bumper collides with another vehicle the vehicles are deflected from each other and the bumper lattice crumples to give a progressive deceleration which reduces the risk of injury or death to passengers in the vehicle, wherein the lattice includes diamond, honeycomb or circular gaps between the panels.

20. The safety bumper of claim 19 wherein the lattice of panels are mounted, extending perpendicularly, on a correspondingly shaped framework.
